(19) United States
(12) Patent Application Publication
(10) Pub. No.: US 2004/0245210 A1
(43) Pub. Date: Dec. 9, 2004

(54) Method for the manufacture of printed circuit boards with embedded resistors

(76) Inventors: Peter Kukanskis, Woodbury, CT (US); Frank Durso, Cheshire, CT (US); Steven Castaldi, Torrington, CT (US); David Sawoska, Watertown, CT (US)

Correspondence Address: John L. Cordani, Carmody & Torrance LLP, P.O. Box 1110, 50 Leavenworth Street, Waterbury, CT, 06721-1110, US

(21) Appl. No.: 10/457,197

(22) Filed: Jun. 9, 2003

(51) Int. Cl. H01B 13/00

(52) U.S. Cl. 216/13

(57) ABSTRACT

A process is revealed whereby resistors can be manufactured integral with a circuit board by printing the resistors onto the insulative substrate. Uniformization of the insulative substrate through etching is discussed as a technique for improving the uniformity and consistency of the printed resistors. Trimming and baking are also disclosed as methods for adjusting and stabilizing the resistance of the printed resistors.

### FIELD OF INVENTION

The present invention relates to a process for the manufacture of double-sided or multilayer printed circuit boards with embedded resistors. The method proposed produces circuits with integral resistors, which are printed in place on the surfaces of the printed circuit board, or on the inner cores of multilayer printed circuit boards thereby opening the area on the surface of the board for placement of active devices. The process produces circuit boards with resistors in a manner that is more efficient and economical than previously possible.

### BACKGROUND OF THE INVENTION

In the manufacture of circuits, it is now commonplace to provide planar boards having circuitry on each side thereof (e.g. double-sided circuit boards). It is also commonplace to produce boards comprised of integral planar laminates of insulating substrate and conductive metal, wherein one or more parallel innerlayers or planes of the conductive metal, separated by insulating substrate, are present within the structure, with the exposed outer surfaces, along with the inner planes, of the laminate containing circuit patterns (e.g. multilayer circuit boards).

In double sided and multilayer circuit boards, it is necessary to provide interconnection between or among the various layers and/or sides of the board containing the conductive circuitry. This is achieved by providing metalized, conductive thru-holes or plated vias in the board communicating with the sides and layers requiring electrical interconnection. The predominantly employed method for providing conductive thru-holes and vias is by electroless deposition of metal on the non-conductive surfaces of the thru-holes, which have been drilled or punched through the board. Typically the electroless deposition is followed by electrolytic deposition of metal in the holes to build conductive metal to the required thickness. Recently some processes have allowed for direct electroplating in the thru-holes without need for prior electroless deposition.

The typical manufacturing sequence for producing printed circuit boards begins with a copper-clad laminate. The copper clad laminate comprises a glass reinforced epoxy insulating substrate with copper foil adhered to both planar surfaces of said substrate, although other types of insulating substrates such as paper phenolic and polyimide, have been used. First the thru-holes are drilled or punched in the copper clad laminate thereby exposing the hole surfaces of insulating substrate material. The holes are then subjected to a chemical plating process which deposits conductive metal in the holes as well as on the copper surfaces. A plating mask is provided on the outer surfaces in the negative image of the circuitry desired. Subsequently copper is electroplated on all surfaces, not covered by the plating mask, to a predetermined thickness, followed by a thin deposition of tin to act as an etch resist. The plating resist is then stripped and the exposed copper surfaces (i.e., those not plated with the etch resist) are etched away. Finally the etch resist is removed and the circuit board is finished with one of a number of known finishing methods such as solder mask, followed by hot air solder leveling. The foregoing process is typically called the pattern plate process and is suitable for producing double-sided printed circuit boards or multilayer boards. However, in the case of multilayer boards the starting material is a copper clad laminate which comprises inner planes of circuitry called innerlayers.

Simple printed circuit boards and the innerlayers of a multilayer circuit board are produced through a technique called print and etch. In this manner a photopolymer is laminated or dried on the copper surfaces of a copper clad laminate. The photopolymer is then selectively imaged using a negative and developed to produce a positive image of the desired circuit pattern on the surfaces of the copper clad laminate. The exposed copper is then etched away and the photopolymer stripped, revealing the desired circuit pattern.

The semi-additive process may be used in conjunction with the print and etch process to produce double sided or multilayer print and etch boards with plated thru-holes. In this process a copper clad laminate or a multilayer package with copper foil on the exterior surfaces is processed through the print and etch process as given above. Holes are then drilled in the board in a desired array. A plating resist applied to cover substantially the entire outer surfaces of the board except for the holes and the circuits. Typically, a separate desensitizing mask is applied, the holes are activated and the desensitizing mask is then stripped away without disturbing the activation. The exposed areas are then plated electrolessly.

In addition to the foregoing, many other processes have been utilized to produce printed circuit boards. Some of these processes are detailed in U.S. Pat. Nos. 3,982,045, 4,847,114 and 5,246,817, the teachings each of which are incorporated herein by reference in their entirety. However, in the prior art processes, the circuits are made such that resistors, if required, need to be provided externally from the circuit board itself. (e.g. mounted on the surface of the circuit board as an appendage).

The concept of embedded passive technology (EPT) is to fabricate passives such as resistors, inductors, and capacitors into printed wiring boards (PWBs) during the board fabrication process. Compared with integrated passives, which consist of passive arrays and networks on carrier substrates, embedded passives are relatively recent. The concept of EPT is driven by multiple factors, such as the need for better electrical performance, higher packaging density and potential cost savings. Using this technology, passives may be placed directly below the active device. The passive component may be placed on an inner layer core, the outer board surface, or some other position determined to be electrically prudent. The shorter the distance between the passive and active components the lesser the parasitic effects associated with surface mounted passives, resulting in better signal transmission and less cross talk.

Current systems in production or under development use screening to deposit ceramic components onto a copper foil that then must be fired to cure the material, or use plating or vapor deposition to place resistive metal or dielectric upon a copper foil, which is then used to make the passive components. All of these systems require many production steps prior to completing the final product. Screening of polymer thick films, (i.e. inks/pastes), is also used to place material for passive components, however, although the steps are fewer, the screening of large circuit boards (18×24 inch) creates a registration problem that worsens as the screen ages. A further disadvantage to screen-printing is that it is often difficult to print on uneven surfaces. Methods for depositing thick film by screen printing, are disclosed by U.S. Pat. No. 6,507,993 to Dunn, the subject matter of which is herein incorporated by reference in its entirety.

Alternative methods for producing embedded passive components include compressing ceramic ZnO powder into discs followed by sintering and firing with microwave radiation as taught by U.S. Pat. No. 6,399,012 to Agrawal, et al., the subject matter of which is herein incorporated by reference in its entirety. Other methods to produce embedded passive components are taught by U.S. Pat. No. 6,317,023 to Felton, the subject matter of which is herein incorporated by reference in its entirety.

A process whereby reliable resistors can be printed as an integral part of the circuitry of the printed circuit board is disclosed herein. This provides for an efficient and economical way of providing the necessary resistors. In addition the process provides for further miniaturization of the printed circuit boards produced in comparison to those produced by prior art methods. Typical prior art in this regard are U.S. Pat. Nos. 3,808,576 and 2,662,957, the teachings both of which are incorporated by reference herein in their entirety. This invention produces circuits with integral resistors, which resistors have a particularly constant resistance as is required by the most demanding applications.

### BRIEF DESCRIPTION OF THE FIGURES

Collectively the figures visually show the steps of the basic process of this invention.

FIG. 1A represents one side of the copper clad laminate (although both sides would most likely be processed in the same way) with insulating dielectric substrate, 10, and the attached copper foil, 11.

FIG. 1B indicates the presence of an imaged resist, 12, on the copper foil, 11. The resist, 12, has already been imaged and developed and therefore covers only the desired portions of the copper foil, 11.

FIG. 1C indicates that the exposed copper has now been etched away leaving unconnected resist covered copper traces, 13 and 14 on the substrate, 10.

FIG. 1D indicates that the resist has now been completely stripped away leaving only the desired copper traces, 13 and 14 on the substrate, 10.

FIG. 1E shows the printed resistor, 16, connecting the previously unconnected copper traces, 13 and 14.

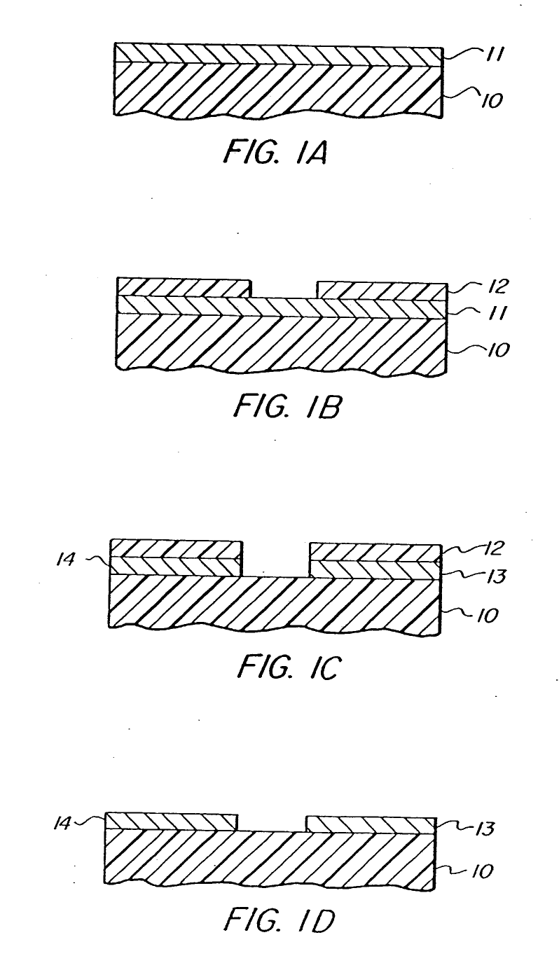

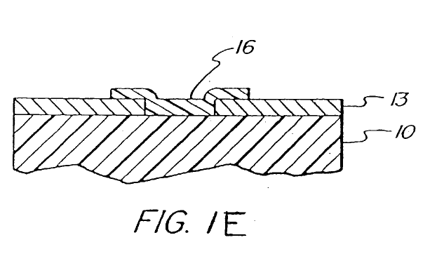

### SUMMARY OF THE INVENTION

The current invention proposes a process for printing resistors as an integral part of a printed circuit board. The foregoing process is described in its basic form by the following sequence of processing steps:

a). Apply an etch resist (12) onto the copper foil (11) surface of a metal clad laminate (or multilayer package) in a desired pattern. The desired pattern should preferably define the conductive circuits desired in a positive manner and should define the areas between the circuits and locations for the resistors in a negative manner;

b). Etch away the exposed copper and preferably remove the etch resist to form unconnected copper traces (13 and 14);

c). Using a printing pad to selectively apply a resistive material such as a resistive paste or polymer in the areas where resistors are desired such that the resistive material connects otherwise unconnected conductive circuits.

As an equivalent to the foregoing process, foregoing steps a and b can be replaced by an additive process with the following steps:

a.1.). Activate the surfaces of a bare dielectric substrate to accept plating thereon;

a.2.). Apply a plating mask to the dielectric substrate such that the desired circuits are defined in a negative manner and the areas between the circuits and the locations for the resistors are defined in a positive manner;

a.3.) Plate the desired circuitry;

a.4.) Strip away the plating resist; and

Subsequently follow step (c) noted previously.

In a preferred embodiment the substrate may be subjected to a dielectric etchant after step b but before step c in order to uniformize the dielectric surface. Etching at this point to uniformize the dielectric surface will provide printed resistors with more constant and predictable resistance.

In a third preferred embodiment, the printed circuit board is subjected to a cleaning step after step (c) in order to remove any residual species and to otherwise improve the surface insulation resistance of the board in general. The inclusion of this step produces printed circuit boards with higher reliability.

Finally trimming is suggested as a method for adjusting the resistance value of the printed resistors to within a prescribed range of resistance (ohms). Ablating portions of the printed resistor using laser light is a particularly preferred method of trimming.

### DETAILED DESCRIPTION OF THE INVENTION

The processes described herein provide a method of forming a resistor between two conductive areas, which areas are upon and separated by an insulating substrate. The method described provides for printing a resistive material onto the insulating substrate, which is between the conductive areas, such that the resistive material connects the conductive areas. The processes described are particularly useful in producing printed circuit boards with printed resistors which are integral with the circuits. The most basic processing sequence is described as follows:

a). apply an etch resist onto the surfaces of a metal clad laminate such that the resist defines the desired circuits in a positive manner and the areas between the circuits, including the locations for the resistors, are defined in a negative manner;

b). etch away exposed copper surfaces and preferably strip the etch resist;

c). optionally, treat the exposed dielectric surfaces with a process selected from the group consisting of chemical etching, plasma etching, laser normalization, vapor blasting, sanding, shot blasting and sand blasting;

d). selectively applying a resistive material such as a conductive paste or conductive polymer with a printing pad in areas where a resistor is desired such that the resistive material connects otherwise unconnected conductive circuits;

e). optionally, bake the resistors;

f). optionally clean the surfaces of the printed circuit board;

g). optionally, trim portions of the printed resistor material such that the final resistance of the resistors falls within a predetermined range of resistance; and

h). optionally, coat the resistors with a protective coating.

Steps (a) and (b) together call for the creation of defined circuitry on the surfaces of a metal clad dielectric laminate (or multilayer package—several layers of circuitry containing one or more innerlayers of circuitry which have been laminated into a single planar package). The innerlayers may or may not contain the printed resistors of this invention. If so, then the innerlayers may be fabricated by the process described herein. Collectively metal clad dielectric laminate and multilayer packages are referred to as metal clad laminate. The metal clad laminate may optionally have thru holes or vias in it in a desired array. The thru holes or vias may or may not be plated at this point. The key here is the definition and creation of circuit patterns on the surfaces of the metal clad laminate along with the definition and creation of specific breaks in the circuitry where the resistors will be printed (the “resistor areas”). The length and width of the specific resistor areas will obviously directly impact the resistance achieved after printing the resistor and should take into consideration the resistance of the material to be printed and the thickness of the material to be printed.

The definition and creation of circuitry and the resistor areas can be accomplished in many ways. The most prevalent way is through the subtractive process as described in current steps (a) and (b). In the subtractive process, a metal (usually copper) clad laminate is used. The metal clad laminate comprises a planar dielectric substrate with metal foil adhered to both exterior surfaces. As discussed, the dielectric substrate is typically glass reinforced epoxy, but can also be a variety of other insulative materials known in the art. In any case, a resist pattern is applied to the metal surfaces of the metal clad laminate such that the resist defines the circuits in a positive manner, and the areas between the circuits and the resistor areas in a negative manner. The most typical way of accomplishing this is to use a photoresist. In this case the photoresist is applied to the metal surfaces in either liquid or dry form. The photoresist is then selectively exposed to actinic radiation through a negative. The unexposed areas of the resist are developed away revealing the desired pattern. As an alternative, the resist may be screened onto the metal surfaces directly in the desired pattern. After the circuits are defined with the resist, the exposed copper areas are etched away and the resist is stripped revealing the circuits. Thus the areas between the circuits and the resistor areas are now bare dielectric.

Step (c) is optional, but recommended. In order for the resistors to be usable and reliable, the resistance must be predictable, relatively constant and reliable. In order to achieve printed resistors with particularly predictable, relatively constant and reliable resistance, the dielectric surface to be printed with the resistive material to form the resistor must be uniform. Dielectric surface uniformity and predictable, relatively constant and reliable resistance of the printed resistors can be accomplished by uniformizing the dielectric surface upon which the resistor is to be printed. Uniformizing can be achieved in several ways such as vapor blasting, chemical etching, plasma etching, laser normalization or mechanical uniformization. Mechanical uniformization can be achieved by sanding, sand blasting or shot blasting. Surface uniformization through chemical etching is generally the most reliable and efficient means. The particular etchant used in this regard must be matched with the dielectric being used. However, if glass reinforced epoxy is used, the inventors have found that alkaline permanganate, concentrated sulfuric acid, chromic acid or plasma to be particularly useful in etching and uniformizing the surface of the dielectric. Solutions of sodium or potassium permanganate at concentrations in excess of 50 grams/liter, in 10% by weight caustic solution, at temperatures in excess of 140° F. and for times of 2 to 20 minutes are preferred in this regard. If permanganates are used in this regard they may be preceded with a swellant or sensitizer which makes the dielectric more susceptible to the permanganate etch. A typical swellant for epoxy is m-pyrol applied full strength at from 90-120° F. for from 1 to 5 minutes. In addition the permanganate etch is typically followed by an acid reducing solution which will remove the permanganate residues. Surface uniformity can also be accomplished by the use of reverse treat copper foil on the laminate. Since the reverse treat copper foil has a relatively low, constant tooth structure, when etched away it will leave a relatively uniform surface.

The present invention requires that the resistive material be selectively printed in the resistor areas, but is not limited to a specific printing method of printing thick film passive components on PWBs. It is intended to encompass various methods to deposit thick film materials or other conductive pastes or polymers on a fabricated board via printing. The technology of PWB fabrication is discussed in U.S. Pat. No. 5,270,493 to Inoue et al., the subject matter of which is herein incorporated by reference in its entirety.

Tampon or pad printing is a well known and established method of printing. Pad printing is a good alternative to screen printing especially where the printing surface is irregular, and does not allow for optimal screen printing. Furthermore, very small print can be better achieved by pad printing.

Pad printing may be facilitated by integrating a pad and inking means into one device. U.S. Pat. No. 4,615,266 to DeRoche, et al, the subject matter of which is herein incorporated by reference in its entirety, teaches a printing apparatus that uses a deformable transfer pad. The transfer pad picks up ink from an engraved printing plate, suspended in a face-down and elevated position above the surface to be printed. The transfer pad is inverted by mechanical means and brought into contact with the surface to be printed. DeRoche further teaches that pad transfer printing is a useful technique for printing on various types of surfaces including irregularly shaped objects. Pad printing processes are capable of producing fine pitch resolution to 0.002″ for electronic and semi-conductor components.

The pad printing process enables application of resistive media to the PWB. U.S. Pat. No. 5,392,706 to Drew, et al., the subject matter of which is herein incorporated by reference in its entirety, teaches printing wherein an inked image is lifted from the engraved area of an engraved printing plate and is transferred to a surface to be printed by a resilient ink transfer pad, normally made of silicone rubber. The surface characteristics of the silicone rubber are such that the ink easily releases from the pad and adheres to the print receiving surface. The transfer pad typically can elastically deform during printing so that virtually any type of raised or irregular shaped surface can be printed, in addition to flat surfaces. A synthetic or metallic cliche is the base for pad printing. The cliche is etched with a print-image and inked. Surplus ink is stripped off by a metal blade (often referred to as a doctor blade) or closed cup using a metal or ceramic ring and ink stays only within the etchings. The silicon pad contacts the cliche, soaking up the ink from the slots. Afterwards the print is transferred to the respective material or part.

In addition to pad printing, thermal transfer printing is another printing method by which thick film resistive media may be deposited onto a PWB. U.S. Pat. No. 6,504,559 to Newton et al., the subject matter of which is herein incorporated by reference in its entirety, teaches a method for applying an image onto a substrate using a digital thermal transfer printing process. The process is particularly suitable for applying a ceramic ink to a substrate which is then fired to completion. Such printing techniques may also be used to embed passive components by applying thick film resistive media onto a PWB. In the present invention, thick film resistive media (or paste) is substituted for ink, and the media is printed on a PWB similar to the application of ink onto a printed surface.

The preferred embodiment of the present invention includes a means to automate the printing process. Automated printing apparatuses facilitating printing are well known and described in the prior art. For example, U.S. Pat. No. 6,067,904 to Bachmann, the subject matter of which is herein incorporated by reference in its entirety, teaches an inking-pad printing press capable of automating printing. Further, this device may be connected to a computer as taught by U.S. Pat. No. 6,363,849 to Philipp, the subject matter of which is herein incorporated by reference in its entirety.

This invention thus requires, in step (d), that the foregoing printing methods be used to selectively deposit a resistive paste or polymer in the resistor areas, thereby creating the desired resistor between the conductive circuits.

Obviously, the thickness of the material printed has a direct impact on the resistivity of the resultant resistor. The inventors have found that typically it is advantageous to print conductive paste or conductive polymer thicknesses in the range of from 0.05 to 2.5 mils, preferably from 0.10 to 1.0 mils and most preferable from 0.10 to 0.50 mils.

Depending upon the ultimate resistance desired, the following factors may be adjusted to vary the resistivity of the resultant resistor: type of material printed, thickness of the material printed, length of the resistor, width of the resistor and subsequent treatment of the resistor. All of the foregoing factors may be varied to achieve the ultimate resistance desired.

In step (f), it is optionally advantageous to clean the surfaces of the printed circuit board in order to increase the surface resistance of the board. U.S. Pat. Nos. 5,221,418; 5,207,867; and 4,978,422, the teachings each of which are incorporated herein by reference in their entirety, all teach various means of cleaning and increasing the surface resistance of boards as is suggested by step (i) herein. Care must be taken such that the resistance of the printed resistor is not affected by the foregoing cleaning. It may be advantageous to protect the printed resistors, prior to cleaning the board, through use of a coating of some type, permanent or non-permanent. However, unless the resistors are protected, no further chemical processing should preferably occur after trimming, since further processing may affect the resistance value of the resistors.

As stated, it is typically of great importance that the resistivity of the printed resistors be predictable and constant over time. The inventors have discovered that subsequent processing of the printed circuit boards can cause the resistance of printed resistors to change. In particular, the lamination and soldering processes can permanently change the resistance of the resistors. In addition, the inventors have found that baking the resistors after they have been printed can stabilize the resistance of the resistors such that changes in resistance due to subsequent processing are minimized. Thus, the inventors prefer to bake the printed resistors from 30 minutes to 3 hours at from 100° F. to 500° F., preferably for 30 minutes to 1.5 hours at from 300° F. to 500° F., in order to stabilize the resistance of the resistors and minimize any subsequent changes therein. Any change in resistance as a result of baking the resistors, or other subsequent processing, must be anticipated in designing the resistors. Final changes in the resistance value of the printed resistor can be achieved through trimming.

After baking, or after printing if baking is not desired, the resistance of the printed resistors can be measured and adjusted, if necessary, by trimming. Trimming is a method of increasing the resistance of the printed resistors to a predetermined or specified resistance value by trimming, or removing, in a controlled fashion, a portion of the printed resistor such that the specified resistance value is achieved for the device. The trimming or controlled removal is typically accomplished by use of lasers. In this regard, lasers are used to ablate portions of the printed resistor in a precise and controlled manner such that the desired resistance is achieved. Printed resistors are particularly amenable to this form of laser ablation since the printed films are generally relatively thin (i.e., about 0.05 to 2.5 mils). In the alternative, the printed resistors can be trimmed using any method which can reliably remove portions of the printed resistor in a controlled manner. Most preferably, the trimming step will occur as close to the end of the printed circuit processing as possible in order to minimize the possibility of the resistance value changing.

Finally, it is usually desirable to coat the surfaces of the board, including the printed resistors, with a protective coating such as a soldermask. Soldermasks are desirable for the protection of the board in subsequent processing and to enhance the durability of the resulting product. Typical solder mask processing is described in U.S. Pat. No. 5,296,334, the teachings of which are incorporated herein by reference in their entirety.

Resistivity is the inverse value of conductivity. It is commonly expressed by volume resistivity, surface resistivity and/or insulation resistance as provided for under ASTM D 257. Volume resistivity is the resistance between the faces of a unit cube and is equal to V=AR/X were V is the volume resistivity expressed in ohms-cm, A is the cross sectional area of the electrical path (cm²), R is the measured resistance (ohms), and X is the length of the electrical path. Values for volume resistivity for the resistors printed as described in this invention can range from about 500 to about 1×10⁻³ ohm-cm, and preferably range from about 200 to about 1×10⁻² ohm-cm, most preferably range from about 100 to about 1×10⁻¹ ohm-cm. Surface resistivity is the ability of an insulator to resist the flow of a current in its surface and is equal to S=PR/d where S is the surface resistivity expressed in ohms/square, P is a parameter of the guarded electrode (cm) given in ASTM D 257, R is the measured resistance (ohms) and D is the distance between the electrodes (cm). Insulation resistance is measured on a specific device or configuration and is the integrated effect of volume and surface resistivity. Insulation resistance is usually expressed in ohms and relates to a specific device or configuration. The resistors printed as described in this invention have an insulation resistance which ranges from about 10 to about 100,000 ohms, preferably from about 100 to about 10,000 ohms.

In applying the foregoing principles to a particular printed resistor with a particular desired design resistance (i.e. insulation resistance) the following equation is useful:

$$R = \frac{VX}{A}$$

where R=the overall desired resistance of the specific printed resistor (i.e. its insulation resistance).

V=volume resistivity of the printed deposit and is generally approximately constant for a particular printed material.

X=printed resistor length

A=printed resistor cross sectional area (width×thickness)

A typical example may require a printed resistor of 0.010 inches in width, 0.010 inches in length and an overall desired resistance of 1,000 ohms±50 ohms. Using a printed material with a volume resistance of about 1.3 ohm-cm and depositing a thickness of 0.5 mils of the foregoing material, a resistor of the desired overall resistance may be obtained as follows:

$$\begin{matrix}R = \frac{( 1.3 ohm \text{-} cm ) ( 0.010 in )}{5 \times {10}^{- 6} {in}^{2}} \times \frac{1 in}{2.54 cm} \\ R = 1024 ohms\end{matrix}$$

For comparison purposes, the volume resistivity of plated copper circuitry or copper plated through holes on a printed circuit board is typically less than about 5×10⁻⁵ ohm-cm and can preferably range from about 1×10⁻⁶ to about 1×10⁻⁸ ohm-cm. The volume resistivity of the insulative substrate of an FR-4 epoxy-glass printed circuit board is typically greater than about 10⁹ ohm-cm and can preferably range from about 10⁹ to about 10²⁰ ohm-cm.

With the pace of minaturization of electronic devices, the surface area of printed circuit boards has become more compacted and more valuable. As a result, the overall size of resistors printed in accordance with this invention must fit the size requirement of ever-shrinking printed circuit boards. Printed resistors, prepared in accordance with this invention, with volume resistivity in the range of 500 to 1×10⁻³ ohm-cm can be formed with lengths ranging from about 0.002 in. to about 1.0 in., preferably from about 0.005 to about 0.20 in., most preferably from about 0.005 to about 0.080 in. with widths ranging from about 0.002 to about 1.0 in., preferably from about 0.005 to about 0.20 in., most preferably from about 0.005 to about 0.080 in. and with thickness ranging from about 0.05 to about 2.5 mils, preferably from about 0.1 to about 1.0 mils and most preferably from about 0.1 to about 0.5 mils.

Typically the material used to print the resistors will comprise (i) an organic binder and (ii) conductive particles. The organic binder can be one, or a combination, of many typical binders including acrylates, methacrylates, epoxies, polyamides, phenolics, cyanate esters, liquid crystal polymers, polyurethanes and styrene and/or butadiene polymers and copolymers. The binder must be compatible with the conductive particles and must form a paste with the conductive particles which has sufficient viscosity and can be effectively and accurately printed onto the resistor areas. The conductive particles will generally be either carbon/graphite powder or metallic powder, such as silver or copper powder. The size of the conductive particles should be small enough such that it forms a uniform paste with the binder, generally from 1-50 microns on average. In the alternative, instead of a binder and conductive particles, the conductive material may comprise a conductive polymer. Suitable conductive polymers include polyaniline.

In either case, the material should be printable using the printing method chosen, must be able to be cured after being printed and must have a resistivity appropriate for the resistor being formed. The resistivity of the material can be altered by changing the proportion or identity of the conductive particles used or by changing the identity or proportion of the binder used. In the alternative, the identity of the conductive polymer used will alter the resistivity of the material. The material may also contain curing or cross-linking agents which cause the material to cure or polymerize.

In certain cases where the metal circuitry is comprised of copper and wherein the resistors are printed with a material comprising pastes or polymers, the resistor material may react with the copper circuitry over time and thereby cause variation in resistance values or “drift”. Drift is undesirable since it is best to establish and maintain a prescribed resistance. To eliminate or minimize drift, it is preferred to coat the copper circuitry, or at least the portion of the copper circuitry that will come into contact with the resistors, with a more noble or less reactive metal prior to printing the resistors. Suitable coating materials include gold, platinum, ruthenium, silver, palladium or nickel. These can be applied through a number of techniques such as immersion or electroless plating, electroplating or sputtering. Once the protective coating is optionally applied to at least the portions of the circuitry that will contact the resistors, the resistors may be printed.

The following examples are presented for illustrative purposes only and should not be taken as limiting in any way.

### EXAMPLE I

Copper clad glass reinforced epoxy laminates were processed through the following sequence:

1. A dry film resist (Aquamer CF-1.5 available from MacDermid, Inc.) was laminated to both copper surfaces of copper clad laminate. The resist was then selectively exposed to ultraviolet light by exposure through a negative. The negative was designed such that the ultraviolet light impinged upon the circuit areas only. (i.e. circuits defined in a positive manner and the areas between circuits and resistor areas are defined in a negative manner) The unexposed portions of the resist were developed away using a 1% by weight potassium carbonate solution at 90° F. for 30 seconds.

2. The exposed copper surfaces were etched away by spraying copper chloride etchant at 110° F. onto the surfaces until the exposed copper was cleanly etched away. The resist was then stripped away in a 10% by weight caustic solution.

3. An “ink” consisting of a thick film paste was prepared by mixing the following ingredients:

| | % by weight |
|---|---|
| Part A | |
| MacuVia-L ®⁽¹⁾ (binder) | 30.1 |
| Silver Powder (1-3 micron) | 30.1 |
| Graphite Powder (2-15 micron) | 18.8 |
| Diacetone alcohol⁽²⁾ | 21.0 |
| Part B | |
| Ancamine ® 2049⁽³⁾ | 100 |

The ink was formed by mixing 100 parts of Part A with 32 parts of Part B.
⁽¹⁾available from MacDermid, Inc. of Waterbury, CT.
⁽²⁾used as a solvent to adjust viscosity.
⁽³⁾available from Air Products, Inc.

4. The ink was then selectively applied to the resistor areas using a printing pad which had the required image of the desired resistor on it such that the ink was printed in the resistor area (between two conductive circuits) in the image desired.

5. The circuit board, with the printed resistor on it, was then baked at 350° F. for 2 hours.

6. The resistance of the printed resistor was measured at 30 ohms/square (surface resistivity).

### EXAMPLE II

Example I was repeated except that the ink of Example I was replaced by the following:

| | % by Weight |
|---|---|
| Part A | |
| MacuVia ®-L | 35.0 |
| Silver Powder (1-3 micron) | 32.3 |
| Graphite (2-15 micron) | 8.4 |
| Diacetone alcohol | 24.3 |
| Part B | |
| Ancamine ® 2049 | 100 |

100 parts of Part A were mixed with 32 parts of Part B.

The resistance of the printed resistor was determined to be 7 kohms/square (surface resistivity).

What is claimed is:

1. A method of forming a resistor between two metallic circuit traces, which circuit traces have a volume resistivity less than about 5×10⁻⁶ ohm-cm, and which circuit traces are upon and separated by an insulative substrate, which insulative substrate has a volume resistivity greater than about 1×10⁹ ohm-cm, which method comprises printing a resistive material, which resistive material has a volume resistivity of from about 500 to about 1×10⁻³ ohm-cm, onto an area of the insulative substrate between the circuit traces, such that the resistive material connects the circuit traces, wherein the resistive material is printed using a printing plate or a printing pad.

2. A method according to claim 1, wherein the insulative substrate between the circuit traces is treated with a process selected from the group consisting of chemical etching, plasma etching, laser normalization, vapor blasting, sanding, shot blasting and sand blasting prior to plating the resistive material thereon.

3. A method according to claim 1, wherein the resistive material comprises at least one material selected from the group consisting of a binder with conductive particles and conductive polymers.

4. A method according to claim 1, wherein the resistive material is trimmed after printing and wherein the trimming is accomplished by contacting at least portions of the resistive material with laser light such that at least portions of the resistive material are ablated or otherwise removed by such contact.

5. A method according to claim 1, wherein the resistive material is printed to a thickness of from about 0.05 to 2.5 mils.

6. A method for manufacturing a circuit board with integral printed resistors which method comprises:
a). applying an etch resist onto portions of the metal surfaces of a metal clad laminate, which laminate comprises a polymer based core with metal cladding thereupon, such that the resist defines desired circuits in a positive manner and areas between the circuits, including the locations for the resistors, in a negative manner thereby creating exposed metal surfaces and resist covered metal surfaces;
b). etching away the exposed metal surfaces thereby yielding metal circuits separated by exposed areas of the polymer based core;
c.) stripping the resist;
d.) using a printing pad or printing plate to selectively apply a resistive material to selected areas between said metal circuits to connect said circuits;
wherein the resistive material has a volume resistivity of from about 500 to about 1×10⁻³ ohm-cm.

7. A method according to claim 6, wherein the resistive material is trimmed after printing and wherein the trimming is accomplished by contacting at least portions of the resistive material with laser light such that at lease portions of the resistive material are ablated or otherwise removed by such contact.

8. A method according to claim 6, wherein the printed circuit board is cleaned subsequent to step (d).

9. A method according to claim 6, wherein a permanent protective coating is applied to the printed circuit board subsequent to step (d).

10. A method according to claim 6, wherein the resistive material is printed to a thickness from about 0.05 to 2.5 mils.

11. A printed circuit board comprising metal circuits upon and separated by a polymer based substrate wherein the metal circuits are connected at specific points by resistive material which has a volume resistivity of from about 500 to about 1×10⁻³ ohm-cm, which resistive material has been selectively printed, using a printing plate or a printing pad, upon the polymer based substrate to form resistors.

12. A printed circuit according to claim 11, wherein the resistive material is trimmed after printing and wherein the trimming is accomplished by contacting at least portions of the resistive material with laser light such that at least portions of the resistive material are ablated or otherwise removed by such contact.

13. A method of forming a resistor between two metallic areas, which metallic areas are upon and separated by an insulative substrate, which insulative substrate has a volume resistivity of from about 10⁹ to about 10²⁰ ohm-cm, and which method comprises printing, using a printing plate or a printing pad, a resistive material, which resistive material has a volume resistivity of from about 500 to about 1×10⁻³ ohm-cm, onto a portion of the insulative substrate which is between the metallic areas, such that the resistive material connects the metallic areas.

14. A method according to claim 13, wherein the conductive areas are circuits on a printed circuit board.

15. A method according to claim 13, wherein the resistive material is trimmed after printing and wherein the trimming is accomplished by contacting at least portions of the resistive material with laser light such that at least portions of the resistive material are ablated or otherwise removed by such contact.

16. A method for manufacturing a printed circuit board with integral printed resistors which method comprises:
a.) applying an etch resist onto portions of the metal surfaces of a metal clad laminate, which laminate comprises a polymer based core with metal cladding thereupon, such that the resist defines the desired circuits in a positive manner and the areas between the circuits, including locations for the resistors, in a negative manner, thereby creating exposed metal surfaces and resist covered metal surfaces;
b.) etching away the exposed metal surfaces thereby yielding metal circuits separated by exposed areas of the polymer based core;
c.) stripping the resist;
d.) using a printing pad or a printing plate to selectively apply a resistive material to selected areas between said metal circuits to connect said metal circuits;
e.) trimming at least a portion of the resistive material such that each resistor has a resistance equal to from about 10 to about 10,000 ohms, a length of from about 0.005 inches to about 0.20 inches, a width of from about 0.005 inches to about 0.20 inches and a thickness of from about 0.05 to about 2.5 mils.

17. A method according to claim 16, wherein the printed circuit board is cleaned subsequent to step (e).

18. A method according to claim 16, wherein a permanent protective coating is applied to the printed circuit board subsequent to step (e).

19. A method according to claim 16, wherein the resistors overlap onto the metal circuits.

20. A method according to claim 16, wherein the resistors have a length of from about 0.005 to 0.080 inches, a width of from about 0.005 to 0.080 inches and a thickness of from about 0.05 to 2.5 mils.

21. A method according to claim 16, wherein the trimming is accomplished by contacting at least portions of the resistive material with laser light such that at least portions of the resistive material are ablated or otherwise removal by such contact.

22. A method of forming a resistor between two metallic areas, which metallic areas are upon an separated by an insulative substrate, which insulative substrate has a volume resistivity of from about 10⁹ to about 10²⁰ ohm-cm, and which method comprises printing, using a printing plate or a printing pad, a resistive material, which resistive material has a volume resistivity of from about 500 to about 1×10⁻³ ohm-cm, onto a portion of the insulative substrate which is between the metallic areas, such that the resistive material connects the metallic areas and thereafter, heating the resistive material to at least about 100° F. for at least about 30 minutes.

23. A method according to claim 22, wherein the insulative substrate between the metallic areas is treated with a process selected from the group consisting of chemical etching, plasma etching, laser normalization, vapor blasting, sanding, shot blasting and sand blasting prior to plating the resistive material thereon.

24. A method according to claim 22, wherein at least a portion of the resistive material is trimmed from the insulative substrate such that the resistor has an insulation resistance equal to a predetermined amount of ohms.

25. A method according to claim 22, wherein the resistive material is trimmed by contacting at least portions of the resistive material with laser light such that at least portions of the resistive material are ablated or otherwise removed by such contact.

26. A method according to claim 1, wherein the metallic circuit traces comprise copper and wherein at least portions of said metallic circuit traces are coated with a material selected from the group consisting of gold, platinum, ruthenium, silver, palladium and nickel.

27. A printed circuit board according to claim 11, wherein the metal circuits comprise copper and wherein at least portions of said metal circuits are coated with a material selected from the group consisting of gold, platinum, ruthenium, silver, palladium and nickel.

28. A method according to claim 16, wherein the metal circuits comprise copper and wherein at least portions of said metal circuits are coated with a material selected from the group consisting of gold, platinum, ruthenium, silver, palladium and nickel.
